(19) United States
(12) Patent Application Publication
(10) Pub. No.: US 2014/0063585 A1
(43) Pub. Date: Mar. 6, 2014

(54) PHASE-CONTROLLED MAGNETIC MIRROR, MIRROR SYSTEM, AND METHODS OF USING THE MIRROR

(71) Applicants: John G. Hagoplan, Harwood, MD (US); Edward J. Wollack, Clarksville, MD (US)

(72) Inventors: John G. Hagoplan, Harwood, MD (US); Edward J. Wollack, Clarksville, MD (US)

(21) Appl. No.: 13/600,826

(22) Filed: Aug. 31, 2012

(51) Int. Cl. G02F 1/01

(52) U.S. Cl. CPC G02F 1/01; B82Y 20/00
USPC 359/279; 977/762

(57) ABSTRACT

A phase-controllable magnetic mirror, system, and method of use are described. The mirror has a ground plate with a surface, a dielectric layer disposed over the surface and having a plurality of electrically-isolated dielectric sections, the dielectric sections defining a plurality of unit cells. The unit cells change their dielectric constant based on an applied voltage such that cells incident photons having a first phase and re-emit photons having a second, different phase. A method of use includes aberrating a wave front and re-emitting, with a phase-controllable magnetic mirror, a second wave front having a different wave front contour. A system including the phase-controllable magnetic mirror has a processor configured to receive aberration measurements and provide selected bias voltages or illumination of the unit cells to make the re-emitted wave front have less aberration than the incident wave front.

### ORIGIN OF INVENTION

The invention described herein was made by an employee of the United States Government, and may be manufactured and used by or for the Government for governmental purposes without the payment of any royalties thereon or therefore.

### FIELD

The aspects of the present disclosure relate generally to adaptive optics for wave front control. More specifically, the aspects of the present disclosure relate to a phase controlled magnetic mirror, optical system having such a mirror, and related methods for controlling wave front aberration.

### BACKGROUND

Optical systems use optical elements such as lenses and mirrors to transmit light. In transmitting light, optical elements alter the contour of a wave front of the light. For example, conventional mirrors reflect light, receiving incident light from a first direction, and re-emitting light in a second direction with an inverted phase relative to the incident light. A traditional mirror reflects an incident wave out of phase with the incident wave. A magnetic mirror reflects an incident wave in phase with the incident wave. Lenses refract light, changing the direction of incident based on the material from which the lens is constructed and it geometry. Ideally, reflection or refraction of the light changes the wave front in a desired way. In practice, deviations from the ideal occur which are related to the variations in material properties and geometric errors from the design specification.

A wave front is a locus of points defining a 2D surface orthogonal to the optical path of the system. And while an ideal lens or mirror changes wave front contour only an intended way, practice such elements also impart unintended changes to a transmitted wave front. As discussed herein, such unintended change to the wave front contour is wave front aberration.

Aberration is also cumulative in optical systems having multiple optical elements. The greater the number of optical elements, the greater the cumulative aberration possible resultant from element manufacturing variation, element misalignment, and degradation from environmental effects. Since optical systems can only tolerate a finite amount of aberration before the transmitted wave front no longer suits its intended purpose, aberration must be carefully controlled during system construction, generally through qualification and testing, and operation, through a monitoring program.

Optical systems are increasingly sensitive to smaller amounts of wave front aberration. For example, lithography systems which define microprocessor circuitry use optical elements to transmit an image of the circuit to a substrate upon which the microprocessor is formed. Aberration may alter the transmitted image to the point where the resulting microprocessor no longer functions as intended. And since successive generations of microprocessors require smaller circuitry features, successive generations of lithography systems require less aberration in the system wave front. Similarly, optical instruments used for gravity wave detection and planet finding systems, such as NASA's Laser Interferometer Space Antenna and Fourier-Kelvin Stellar Interferometer, require extremely small amounts of aberration in the system wave front to achieve the desired system performance]. And while care optical element construction, alignment, and operating environment may be controlled to mitigate and control these system parameters, the costs of such control can become prohibitive.

One method of controlling aberration is to incorporate a mechanically actuated lens into the optical train of the system. A mechanically actuated lens has actuators that change (e.g. tilt, shift) the alignment of the lens with respect to optical axis of the system, thereby redistributing (smoothing) the transmitted wave front's contour [ ].

Another method uses is to incorporate a mechanically deformable mirror into the optical train of the system. A mechanically deformable mirror has actuators that locally deform the mirror, causing the mirror to assume a non-flat shape, thereby reflecting light differently in the non-flat portion of the mirror and changing the reflected wave front contour at a given wave front location.

Each of these methods can address only a limited amount of aberration. Mechanically actuated lenses induce wave front change across the entire wave front, and while they may improve the wave front in one location, they may worsen the wave front contour in other regions of the wave front. Mechanically deformable mirrors are limited by the size of the associated actuators, the actuator inducing unintended mirror surface changes in the vicinity of the intended surface change. Neither approach is effective at correcting the complex wave front contours associated with the higher order aberrations and residual aberration to which some optical systems are now sensitive.

Consequently, there is a need for an optical element capable of controlling complex wave front shapes. There is a further need for an optical element capable of controlling complex wave front shapes, reducing the total wave front aberration to very small levels.

Accordingly, it would be desirable to provide a mirror and mirror system that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a phase-controllable magnetic mirror. In one embodiment, the magnetic mirror includes a ground plate having a surface, a dielectric layer disposed over the ground plate surface having a plurality of electrically-isolated sections. The sections define unit cells connected to the ground plate and the dielectric layer, and have an associated nanostructure disposed over the section. Upon application of a bias voltage, the dielectric properties of the unit cell changes, thereby varying the phase of a photon re-emitted by electrons oscillating within the nanostructure.

Another aspect of the exemplary embodiments relates to a method of controlling wave front aberration. In one embodiment, the method includes, at an optical system having a phase-controllable magnetic mirror, receiving an aberrated wave front at the magnetic mirror, re-emitting a corrected wave front having at least one aberrated portion of the aberrated wave front phase-corrected by applying a determined bias voltage to a unit cell of the magnetic mirror. The re-emitted wave front has less aberration the received wave front.

A further aspect of the exemplary embodiments is directed to a phase-controllable magnetic mirror system. In one embodiment, the system has a phase-controllable magnetic mirror with a plurality of unit cells, the unit cells each having a dielectric constant changeable with a bias voltage or illumination and a nanostructure disposed over a surface of the unit cell. A processor connected to the magnetic mirror and an aberrometer has instructions that cause the processor to receive wave front measurement prior to its arrival at the mirror, analyse the wave front aberration, calculate corrections to the wave front resultant from selectively varying the phase of light re-emitted by the mirror unit cells, and applying bias voltages to the mirror unit cells such that the re-emitted wave front has less aberration than the wave front received at the mirror.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 shows a three-dimensional perspective view of light propagating through space with a uniform wave front;

FIG. 2 shows a two-dimensional view of a wave front changing as a result of passing through a lens;

FIGS. 3A-3E show representative two-dimensional and three-dimensional plots of wave front aberration patterns associated with an expansion of Zernike's equation;

FIG. 4 shows an embodiment of a phase-controlled magnetic mirror;

FIG. 5 shows a unit cell of a phase-controlled magnetic mirror having a ring-shaped nanostructure;

FIG. 6 shows a unit cell of a phase controlled magnetic mirror having a sinusoidal-shaped nanowire;

FIG. 7 shows a phase-controllable magnetic mirror system; and

FIG. 8 shows a method of using a phase-controllable magnetic mirror to control aberration in a wave front propagating through an optical system.

### DETAILED DESCRIPTION OF THE EXEMPLARY EMBODIMENTS OF THE DISCLOSURE

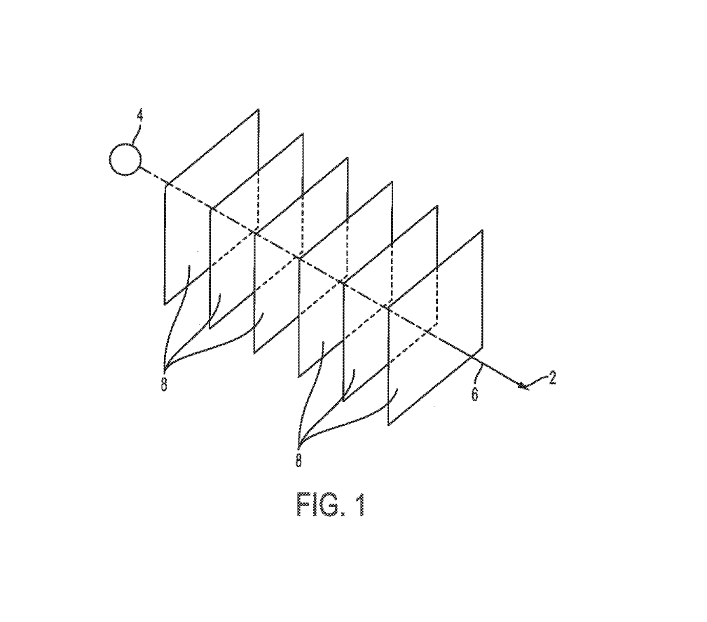

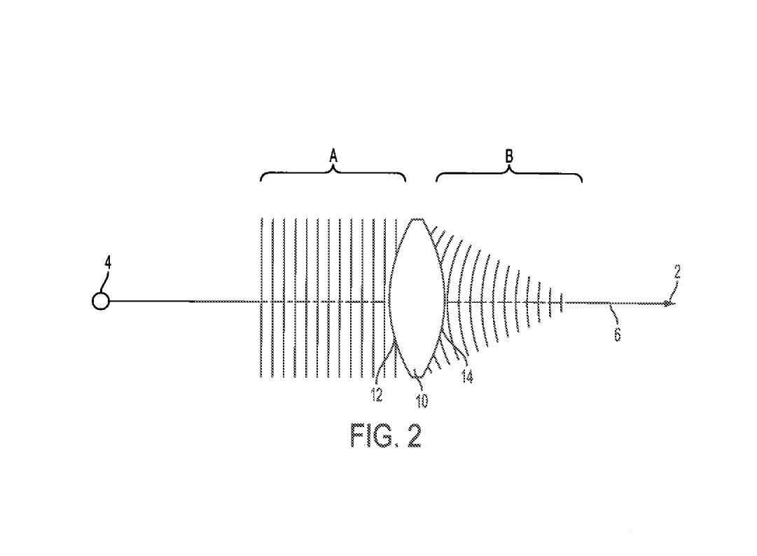

FIG. 1 is three-dimensional, perspective view of light propagating through space in a uniform phase. Light 2 propagates through space from a light source 4 along an axis 6. As the light propagates along axis 6, the light 2 comprises a wave front 8. Wave front 8 is shown in FIG. 2 as a series of parallel, planar surfaces oriented orthogonally with respect to the axis 6. These planar wave front surfaces 8 illustrate that the light comprises an ideal, substantially aberration free, wave front. Wave front 8 is also shown as finite set of wave front planes; this is illustrative only, wave front 8 comprises an infinite and continuous set of wave fronts along the axis 6. The discussion herein generally refers to embodiments using visible light. However, this is for illustrative purposes only. Embodiments of the apparatus, methods, and systems described herein may be used to control the wave front associated with other forms of electro-magnetic radiation, such as infrared, millimeter wave and radio, the feature size (critical dimension) of the unit cell being selected for the wavelength (or range of wavelengths) of the incident radiation, smaller features sizes being effective for smaller wavelengths of incident radiation. Consequently, embodiments using other forms of radiation are within the scope of the present disclosure.

FIG. 2 is a two-dimensional, plan view, of light propagating through an optical element 10 along the axis 6. Element 10 is a lens having opposed convex surfaces that refract light arriving on an input face 12 to an output face 14 by different length paths through the media composing the lens. Lens 10 changes the wave front defined by 6, light incident on the input face 12 having a flat wave front A, and light leaving the output face 14 having a curved wave front B. As would be recognized by one of skill in the art, the two-dimensional curve associated with wave front B is a three-dimensional cone shape.

Lens 10 comprises an ideal lens. Therefore, the difference between wave front A and wave front B is a second order function having the equation:

W_{B}=Ax²+Bx+C

where A and B are coefficients depending upon the geometry of the lens, and C being a residual term equal to zero.

More complicated wave front shapes than that illustrated in FIG. 2 may be understood using Zernike's equation. Zernike's equation may be written:

$$W = \overline{Δ W} + \text{?} [ {A}_{n} {Q}_{n}^{0} ( ρ ) + {\sum }_{m = 1}^{n} {Q}_{n}^{m} ( ρ ) {ρ}^{m} ( {B}_{nm} cos m \text{?} + {C}_{nm} sin m \text{?} ) ]$$

$$\text{?} \text{indicates text missing or illegible when filed}$$

Zernike's equation may be expanded into an infinite series of polynomial terms followed by a residual term. Typically, for decomposing wave front aberration into cognizable forms of aberration such as astigmatism, coma, and spherical aberration, Zernike's equation is expanded into thirty-six polynomial equations and a residual term, which may be written:

Total Wave Front Aberration=Z1+Z2+ . . . +Z35+Z36+Residual

where Z1 through Z36 are each a polynomial equation describing a cognizable from of aberration, and Z37 being a residual term quantifying remaining error in the wave front contour not captured in the first thirty-six polynomial expansions. When applied to a set of wave front measurements associated with an aberrated wave front, calculated coefficients associated with the polynomials of each term indicate a relative contribution of each type (pattern) of aberration to the total aberration. From such coefficients, a wave front from contour can be described as being dominated by an astigmatism, coma, or spherical aberration. As described above, the effect of an adjustment to an adaptive element (i.e. a movable lens or a mechanically deformable mirror) may be calculated to target the dominant type (or types) of aberration present in the wave front for purposes of controlling the wave front. However, such elements typically only work well for certain types of aberrations, such as Z4 and Z5, and are of limited use in correcting higher order aberrations or at reducing residual aberration (Z37).

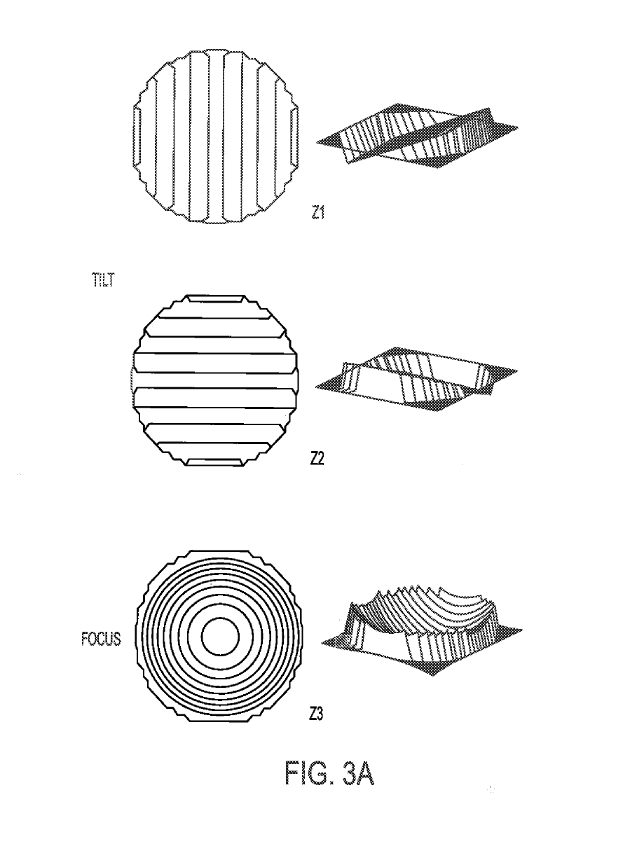

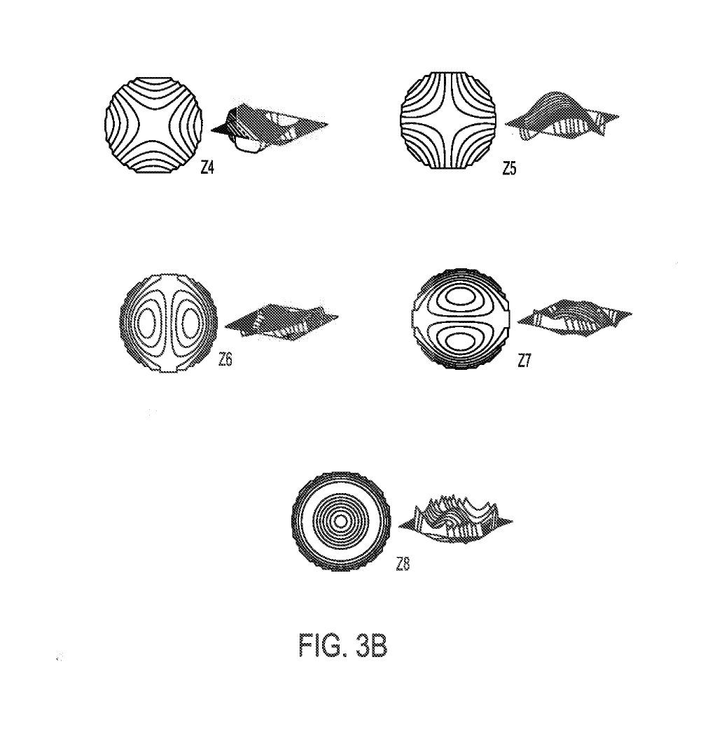

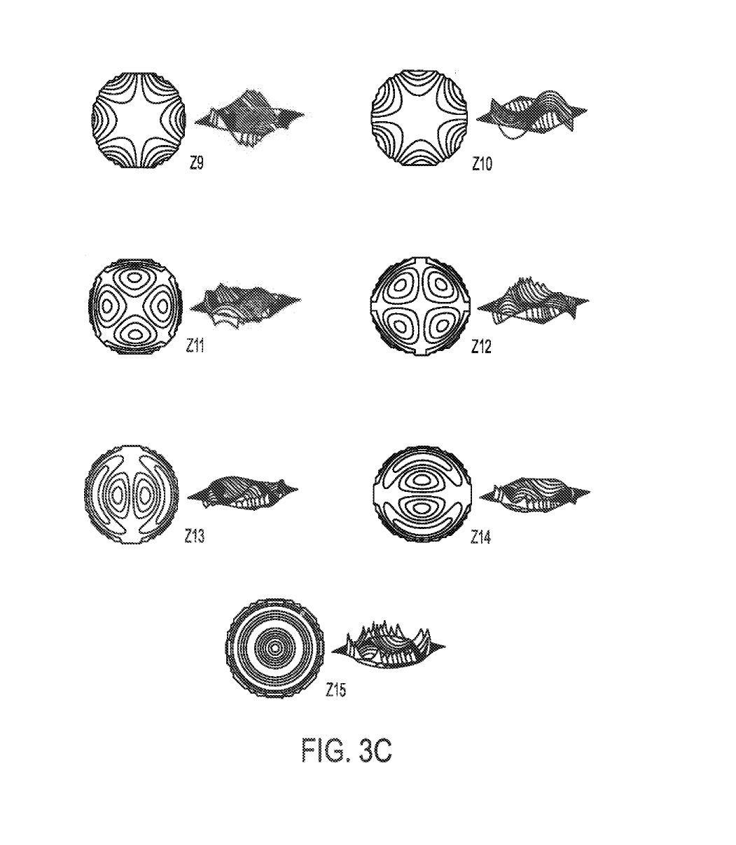

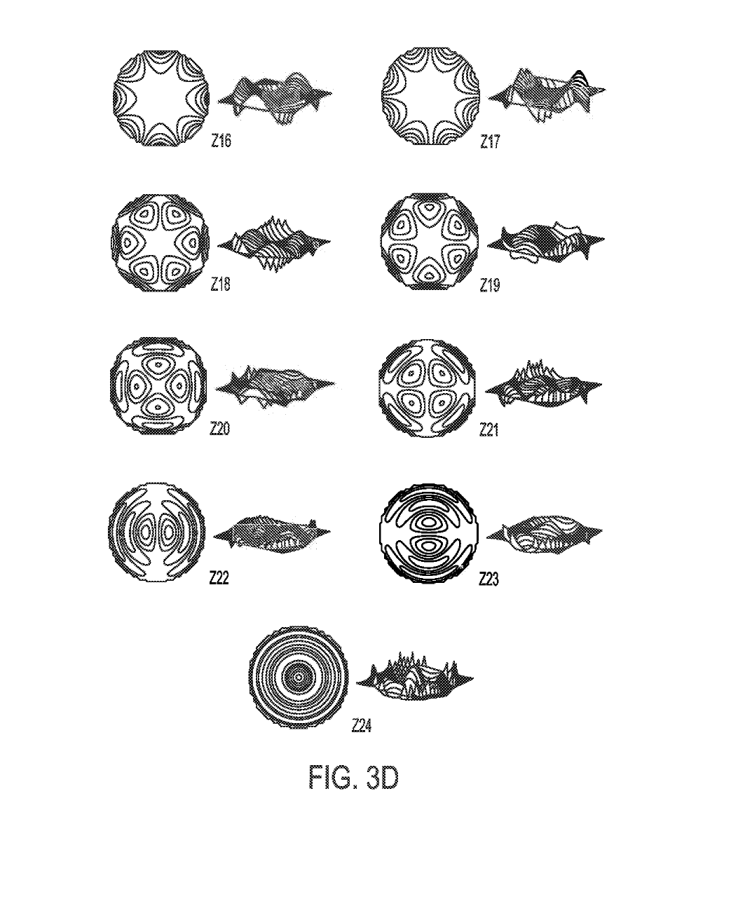

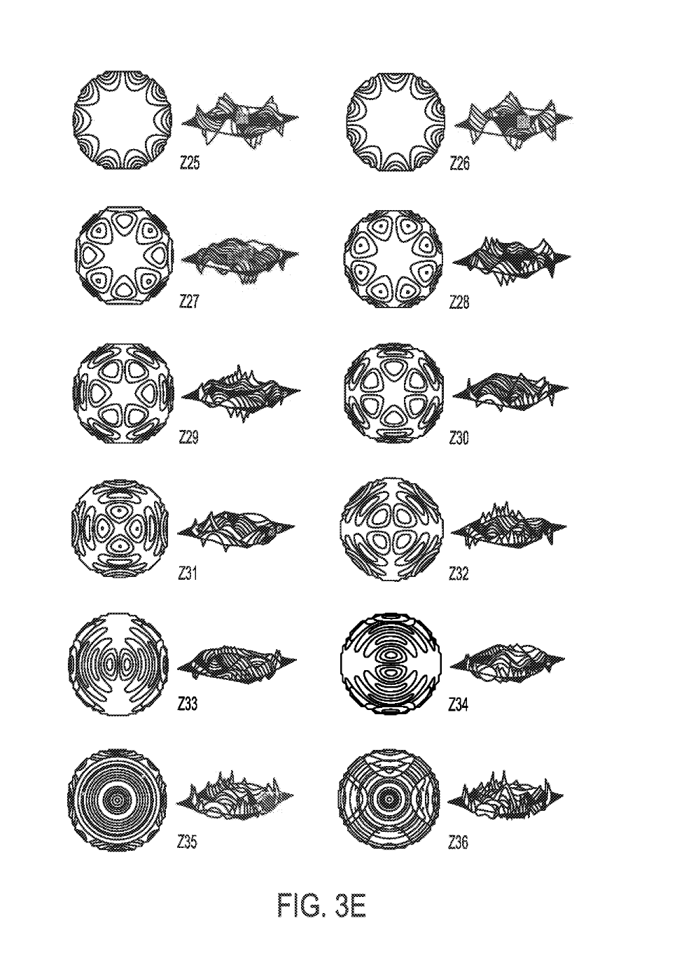

Tables 1 through 5 contain polynomial terms of an illustrative expansion of Zernike's equation. FIGS. 3A-3E show plots of the polynomial terms on respective unit disks (disks having a radius of 1).

Table 1 shows the first-order polynomial equations (equations 1-3) resulting from an expansion of Zernike's equation.

TABLE 1
First Order Aberrations (Z1-Z3)

| | |
|---|---|
| 1 | ρ cos θ′ |
| 2 | ρ sin θ′ |
| 3 | 2ρ² − 1 |

Table 2 shows the second-order polynomial equations (equations 4-8) resulting from an expansion of Zernike's equation.

TABLE 2
Second Order Aberrations (Z4 through Z8)

| | |
|---|---|
| 4 | ρ² cos 2θ′ |
| 5 | ρ² sin 2θ′ |
| 6 | (3ρ² − 2)ρ cos θ′ |
| 7 | (3ρ² − 2)ρ sin θ′ |
| 8 | 6ρ⁴ − 6ρ² + 1 |

Table 3 shows the third-order polynomial equations (equations 9-15) resulting from an expansion of Zernike's equation.

TABLE 3
Third-Order Aberration Equations (Z9 through Z15)

| | |
|---|---|
| 9 | ρ³ cos 3θ′ |
| 10 | ρ³ sin 3θ′ |
| 11 | (4ρ² − 3)ρ² cos 2θ′ |
| 12 | (4ρ² − 3)ρ² sin 2θ′ |
| 13 | (10ρ⁴ − 12ρ² + 3) ρ cos θ′ |
| 14 | (10ρ⁴ − 12ρ² + 3) ρ sin θ′ |
| 15 | 20ρ⁶ − 30ρ⁴ + 12ρ² − 1 |

Table 4 shows the fourth-order polynomial equations (equations 16-24) resulting from an expansion of Zernike's equation.

TABLE 4
Fourth-Order Aberration Equations (Z16 through Z24)

| | |
|---|---|
| 16 | ρ⁴ cos 4θ′ |
| 17 | ρ⁴ sin 4θ′ |
| 18 | (5ρ² − 4)ρ³ cos 3θ′ |
| 19 | (5ρ² − 4)ρ³ sin 3θ′ |
| 20 | (15ρ⁴ − 20ρ² + 6) ρ² cos 2θ′ |
| 21 | (15ρ⁴ − 20ρ² + 6) ρ² sin 2θ′ |
| 22 | (35ρ⁶ − 60ρ⁴ + 30ρ² − 4) ρ cos θ′ |
| 23 | (35ρ⁶ − 60ρ⁴ + 30ρ² − 4) ρ sin θ′ |
| 24 | 70ρ⁸ − 140ρ⁶ + 90ρ⁴ − 20ρ² + 1 |

Finally, Table 5 shows the fifth-order polynomial equations (equations 25-36) resulting from an expansion of Zernike's equation.

TABLE 5
Fifih-Order Aberration Equations (Z25 through Z35)

| | |
|---|---|
| 25 | ρ⁵ cos 5θ′ |
| 26 | ρ⁵ sin 5θ′ |
| 27 | (6ρ² − 5)ρ⁴ cos 4θ′ |
| 28 | (6ρ² − 5)ρ⁴ sin 4θ′ |
| 29 | (21ρ⁴ − 30ρ² + 10)ρ³ cos 3θ′ |
| 30 | (21ρ⁴ − 30ρ² + 10)ρ³ sin 3θ′ |
| 31 | (56ρ⁶ − 105ρ⁴ + 60ρ² − 10)ρ² cos 2θ′ |
| 32 | (35ρ⁶ − 60ρ⁴ + 30ρ² − 4)ρ² sin 2θ′ |
| 33 | (126ρ⁸ − 280ρ⁶ + 210ρ⁴ − 60ρ² + 5)ρ cos θ′ |
| 34 | (126ρ⁸ − 280ρ⁶ + 210ρ⁴ − 60ρ² + 5)ρ sin θ′ |
| 35 | 252ρ¹⁰ − 630ρ⁸ + 560ρ⁶ − 210ρ⁴ + 30ρ² − 1 |

FIG. 3A shows equations 1-3 graphed in two-dimensions (left side) and in three-dimensions (right side) on a unit disk as aberrations Z1-Z3.

FIG. 3B shows equations 1-3 graphed in two-dimensions (left side) and in three-dimensions (right side) on a unit disk as aberrations Z4-Z8.

FIG. 3C shows equations 9-15 graphed in two-dimensions (left side) and in three-dimensions (right side) on a unit disk as aberrations Z9-Z15. FIG. 3D shows equations 16-24 graphed in two-dimensions (left side) and in three-dimensions (right side) on a unit disk as aberrations Z16-Z24.

FIG. 3E shows equations 25-36 graphed in two-dimensions (left side) and in three-dimensions (right side) on a unit disk as aberrations Z25-Z36. As shown in the 2D and 3D figures, certain forms of aberration have relatively complex contours. Such complex contours are difficult to correct using conventional adaptive elements.

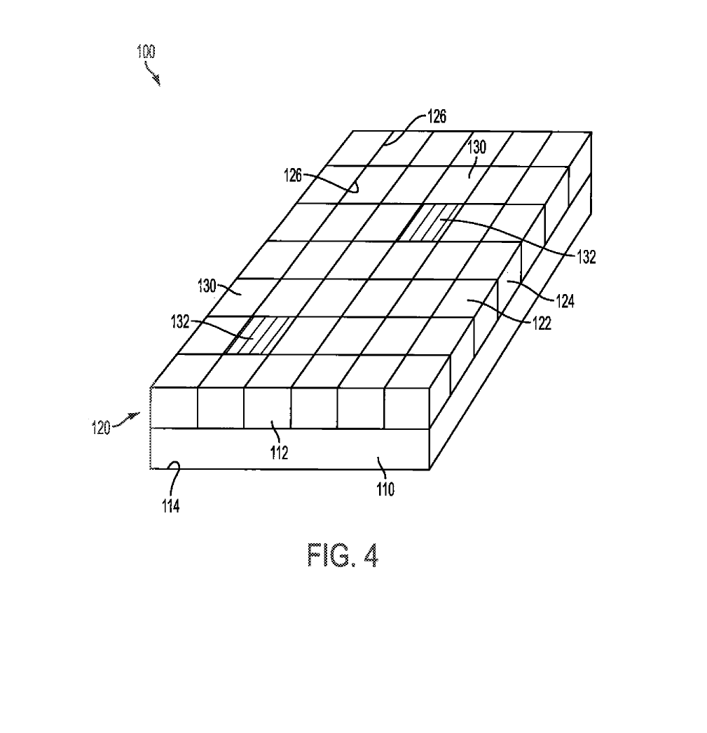

FIG. 4 shows an embodiment of a phase-controlled magnetic mirror 100. The mirror 100 comprises a ground plate 110, a dielectric layer 120, and a plurality of unit cells 130. The ground plate 110 comprises a first surface 112 and a second surface 114. The dielectric layer 120 comprises a first surface 122 and a second surface 124. The dielectric layer 120 is disposed over ground plate 110 such that the dielectric layer second surface 124 substantially covers the ground plate first surface 112. In an embodiment, the dielectric layer 120 covers a portion of the ground plate first surface 112. In an embodiment, the ground plate 110 comprises aluminum.

As also shown in FIG. 4, the dielectric layer 120 further comprises at least one isolation structure 126. Isolation structure 126 divides the dielectric layer 120 into a plurality of dielectric portions, each dielectric portion in turn defining corresponding unit cells 130 in the illustrated embodiment. Unit cell 130 further comprises at least nanostructure 132. In the illustrated embodiment, nanostructure 132 comprises a plurality of substantially linear nanowires extending in a single (common) direction. In an embodiment, the at least one nanowire extends substantially across the entire surface of the dielectric section defined by the isolation structures 126. In an embodiment, nanowires within a unit cell extend in at least two orientations in a single unit cell. In an embodiment, a nanowire in first unit cell extends in an orientation different from that of a second unit cell. As also shown in FIG. 4, the isolation structures 126 define a plurality of substantially uniform, square unit cells 130. In an embodiment, the isolation structures define unit cells having a non-square shape.

The unit cell 130 connects to the ground plate 114 at the dielectric second surface 124, and connects to an electric potential source (voltage source) through a second connection (not shown). The index of refraction of the dielectric within the unit cell 130 varies as a function of the applied electric potential. In an embodiment, the second connection comprises a conductive column of material, such as a via or contact, advantageously allowing large numbers of unit cells to be defined in the dielectric layer and connected to an underlying microelectronic circuit fabricated by conventional microelectronic manufacturing processes. Advantageously, such arrangement allows for adjacent unit cells receive differing electric potentials, the adjacent sections thereby having a different respective index of refraction.

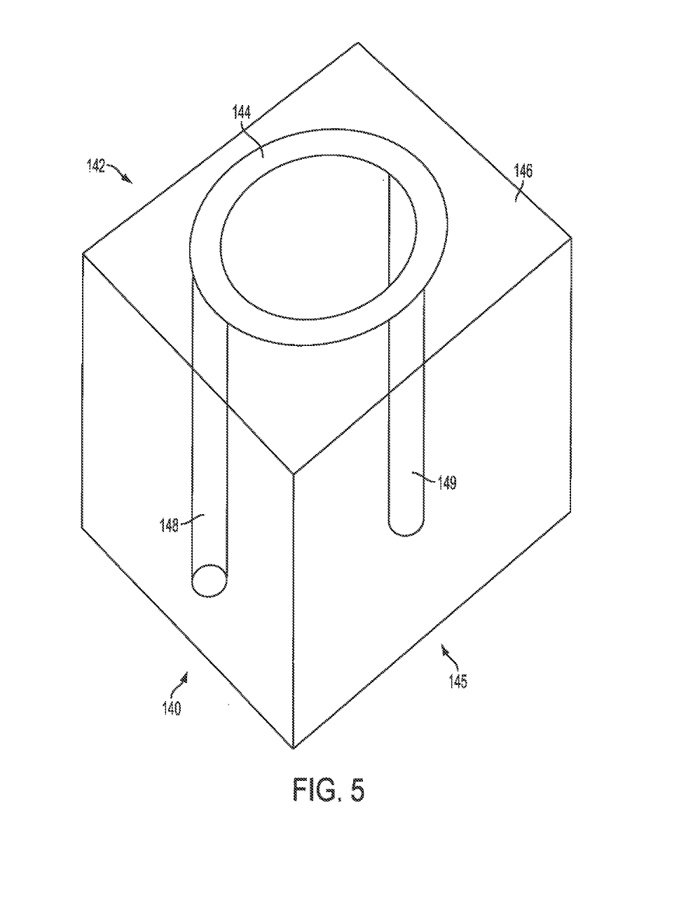

FIG. 5 shows a unit cell 140 comprising a nanostructure 142, a unit cell first surface 146, and a unit cell second surface 145. Nanostructure 142 comprises a ring-shaped segment 144, a first connecting segment 148, and a second connecting segment 149. The first connecting segment 148 electrically couples the nanostructure 142 to the ground plate (not shown). The second connecting segment 149 electrically couples the nanostructure 142 to the electric potential (also not shown). The sinusoidal-shaped segment 144 is disposed such that it crosses at least a portion of the unit cell first surface 146. In an embodiment, at least one of the connecting segments (148, 149) extends beyond the unit cell second surface 145 to electrically couple with another structure.

In an embodiment, the unit cells are configured to correct incident light phase error which is large compared to the wavelength of the incident light. In the embodiment, the unit cell (or pitch), p<lambda/2, of the surface sets the highest spatial frequency that can be corrected. Such a mirror advantageously arranged within an optical system closer to field than to a stop in the system.

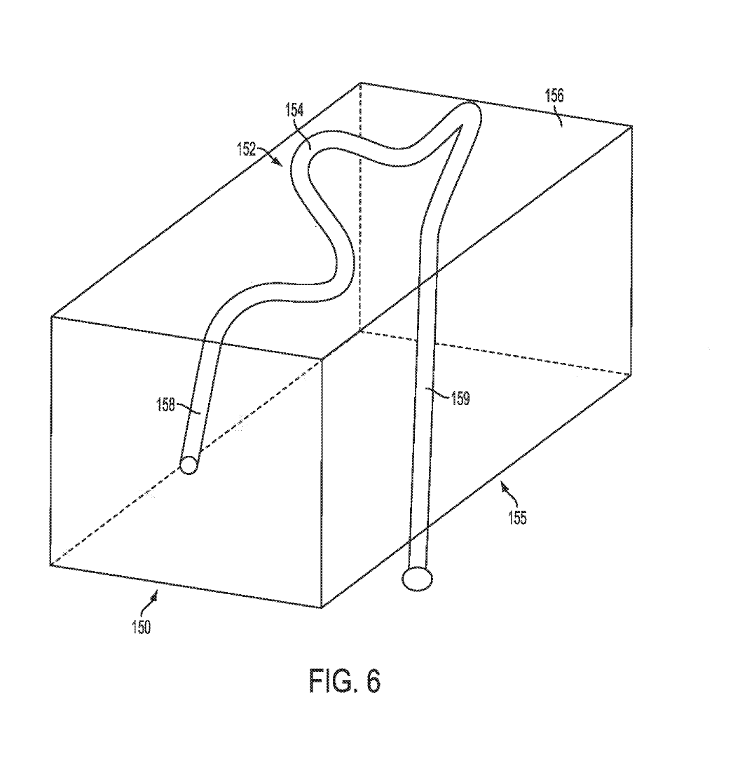

FIG. 6 shows a unit cell 150 comprising a nanostructure 152, a unit cell first surface 156, and a unit cell second surface 155. Nanostructure 152 comprises a sinusoidal-shaped nanowire segment 154, a first connecting segment 158, and a second connecting segment 159. The first connecting segment 158 electrically couples the nanostructure 152 to the ground plate (not shown). The second connecting segment 159 electrically couples the nanostructure 152 to the electric potential (also not shown). The sinusoidal-shaped nano segment 154 is disposed such that it crosses at least a portion of the unit cell first surface 156. In an embodiment, at least one of the connecting segments (158, 159) extends beyond the unit cell second surface 155 to electrically couple with another structure. Advantageously, the sinusoidal-shaped nano wire 154 is relatively simply to manufacture using conventional microelectronic manufacturing processes.

Exemplary embodiments of the unit cells (130, 140, 150) comprise repetitive, sub-wavelength scale conductive structures that interact with light on a nanoscale, thereby enabling synthesis of a magnetic-field boundary condition. Interaction of the light with the nanowires, dielectric layer, and ground plate inverts the magnetic field vector, thereby resulting in a phase shift of the reflected (re-emitted) wave as a function of a voltage applied to the nanostructure. By controlling the voltage applied to the nanostructure(s) the given unit cell, the phase of the reflected (re-emitted) incident radiation can be modulated or controlled. Moreover, by selectively controlling the voltage applied to an individual unit cell or group of unit cells, the response of the magnetic mirror 100 to incident radiation (e.g. light) can be varied across the surface area of the mirror. The change in dielectric function with voltage (or illumination) results in a phase shift, and in an embodiment, a corresponding change in absorption. By characterizing aberration of the incident light at a location between the mirror and the light source, unit cell specific potential differences can be determined and applied to mirror such that the mirror re-emits the light with a wave front having less aberration than the incident wave front. Hence, the plurality of unit cells of the mirror is configured to receive incident photons at a first phase, and selectively re-emit photons at a second phase such that the re-emitted wave front has a smoother contour than the incident wave front contour.

In an embodiment, the dielectric properties of the dielectric layer change in response to a wavelength of light outside of the signal band. Advantageously, the illumination driven deformable magnetic mirror requires no associated underlying microstructure (contacts, vias, or distribution lines) because no bias voltage is necessary to selectively drive a unit cell or group of unit cells. Instead, a unit or group of unit cells is ‘painted’ with out of band illumination to elicit a localized phase response to smooth (or control) the wave front contour.

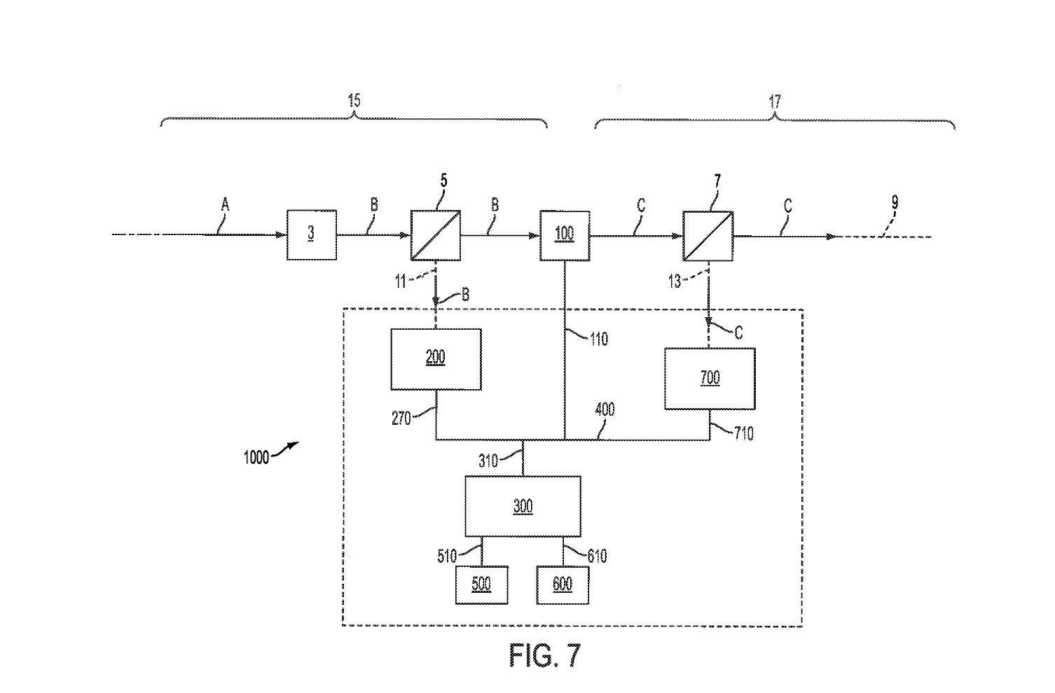

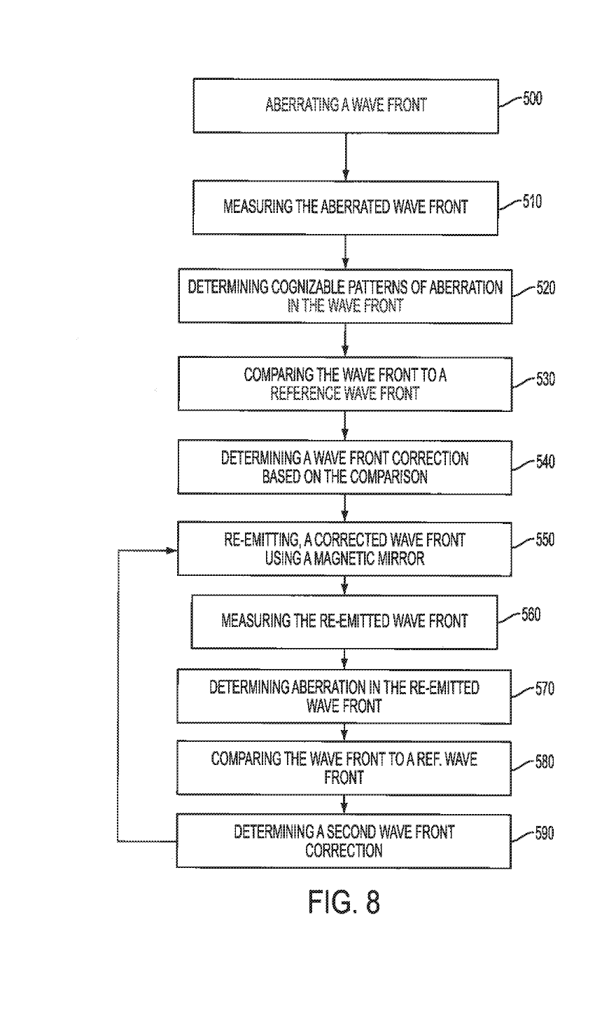

FIG. 7 shows a wave front control system 1000 integrated into an optical system (not numbered). The optical system comprises a front section 15 having an optical axis 9 and a rear section 17 optically coupled to the front section 15 along the optical axis 9. The front section 15 of the optical system further comprises an optical element 3, and a first beam splitter 5. The system further comprises a phase-controlled deformable mirror 100 (also part of the wave front control system 1000) arranged on the optical axis 9 between the system front section 9 and rear section 17 and an optical axis 9. The optical element 3, first beam splitter 5, and the phase-controllable deformable mirror 100 are arrayed along the optical axis 9. The first beam splitter 5 further comprises a first beam splitter axis 11. The optical element 3, first beam splitter 5, and phase controllable deformable mirror 100 are each optically coupled to one another such that light incident on the optical element 3 in transmitted to (and incident on) the first beam splitter 5. The first beam splitter 5 splits the light incident upon it into a first portion and a second portion, the first portion being transmitted to (and incident upon) the phase-controllable deformable mirror 100, and the second portion being directed toward the wave front control system 1000. In an embodiment, the phase-controllable deformable mirror 100 is disposed in a pupil plane of the optical system. Advantageously, disposing the mirror 100 in a pupil plane of the optical system minimizes the surface area of the mirror required to correct substantially all the rays exiting from the optical system, thereby minimizing the size of the system housing the mirror 100 while maintain enough degrees of freedom in the magnetic mirror to correct the desired aberrations.

The wave front control system 1000 comprises a first aberrometer 200, a processor 300, a data communications bus 400, memory 500, and at least one input/output (I/O) interface 600. The first aberrometer 200 is optically coupled to the optical system at the first beam splitter axis 11. The communication bus 400 comprises a data communications link enabling digital communications between the first aberrometer 200, processor 300, memory 500, and I/O device 600. Phase-controllable magnetic mirror 100 communicatively couples directly to the communications bus 400 through a connection 110. Aberrometer 200 communicatively couples to the data bus 400 through a connection 210. Processor 300 communicatively couples to the data bus 400 through a connection 310. Memory 500 communicatively couples to the data bus 400 through a connection 510, the processor 300, and the connection 310. I/O device 600 communicatively couples to the data bus 400 through a connection 610, the processor 300, and the connection 310. In an embodiment, at least one of the memory 500 and the I/O device 600 are communicatively coupled directly to the communications bus 400.

The aberrometer 200 is configured to receive a portion of light transmitted within the optical system having an aberrated wave front, measure the wave front, determine a contour of the wave front, decompose the determined wave front into the polynomial functions describing cognizable aberrations and/or a residual term, determine a corresponding complementary phase corrections executable by the phase-controllable magnetic mirror 100, and communicate those corrections to the mirror 100. In an embodiment, at least one of these functions is executed by the processor 300. In an embodiment, the aberrometer 200 comprises a Shack-Hartmann wave front sensor.

The processor 300 may further comprise a computer having at least one or more processors or processing units and a system memory. The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, USB memory devices, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The at least one memory 500 comprises at least one non-transitory machine readable media such as a hard drive, disk drive, or flash device with instructions encoded thereon that, when read by the processor, cause the mirror control system 1000 to execute the below-described operations and methods.

The at least one I/O device 600 comprises an input device that allows for control of at least one of the aberrometer 200, the phase-controllable magnetic mirror 100, and the processor 300 by an external device and for changing the instructions recorded on the memory 500. In an embodiment, I/O device 600 is a key board.

Operatively, light having an incident wave front contour A enters the optical system, and is transmitted to the optical element 3 along the optical axis 9. The lens 3 receives the incident light, induces a wave front contour into the light, and transmits light having an aberrated wave front B the first beam splitter 5. Aberrated wave front B comprises a wave front having at least one of a lower order aberration, higher order aberration, and residual wave front error. In an embodiment, residual wave front error comprises wave front aberration not quantified by the first thirty-six (36) polynomial terms of an expansion of Zernike's equation. In an embodiment, the lower order wave front error comprises at least one of lower order astigmatism, coma, and spherical aberration. In an embodiment, the higher order wave front error comprises at least one of higher order astigmatism, coma, and spherical aberration.

The first beam splitter 5 divides and transmits incident light having aberrated wave front B into a first portion and a second portion, each light portion having substantially the same aberrated wave front contour. First beam splitter 5 transmits the first light portion, having aberrated wave front contour B, along the optical axis 9 and to the phase-controllable mirror 100. First beam splitter 5 transmits the second light portion, also having aberrated wave front contour B, to aberrometer 200 along the first beam splitter axis 11. The aberrometer 200 receives the aberrated wave front B, measures the aberration of the received wave front, and determines corresponding wave front corrections based on the measured aberrated wave front. These corrections are then converted into unit cell specific voltages which are applied to the mirror 100. In an embodiment, at least one of these functions is performed by the processor 300 using instructions stored on memory 500.

Phase-controllable magnetic mirror 100 receives light comprising the aberrated wave front B along the optical axis 9. Phase-controllable magnetic mirror re-emits the incident light as light comprising a corrected wave front C along the optical axis 9. In an embodiment, corrected wave front C comprises at least one of (i) less lower order wave front aberration than aberrated wave front B, (ii) less higher order wave front aberration than aberrated wave front B, and (iii) less residual wave front aberration than aberrated wave front B. In an embodiment, corrected wave front C comprises a greater amount of aggregate wave front aberration than aberrated wave front B, redistributing the aberration within wave front B such that the aberration contour is correctable using an adaptive optical element (not shown) disposed along the optical axis of the system in the rear section of the system. Advantageously, systems having embodiments of phase-controllable deformable mirror 100 are able to correct greater levels of wave front aberration, including higher order and residual wave front error, than systems having conventional adaptive optics and/or deformable mirrors.

In an embodiment, the optical system further comprises a second beam splitter 7 having a second beam splitter axis 13. The second beam splitter 7 is arranged on the optical axis 9 in the rear section 17 of the system, and is optically coupled to the phase-controllable magnetic mirror 100 so as to receive incident light having the corrected wave front C. The second beam splitter 7 divides and transmits incident light having the corrected wave front C into a first portion and a second portion, each light portion having substantially the same corrected wave front contour C. Second beam splitter 7 transmits the first light portion, having the corrected wave front contour C, along the optical axis 9. The second beam splitter 7 also transmits the second light portion, also having corrected wave front contour C, to the second aberrometer 700 along the second beam splitter axis 13.

The second aberrometer 700 connects to the processor 300 over the communication bus 400 through a connection 710. Operatively, the second aberrometer 700 is configured like the first aberrometer 200. The second aberrometer 700 receives the corrected wave front C, measures aberration in wave front C, and iteratively determine updated corresponding wave front corrections based on the measured corrected wave front C. These corrections are then converted into unit cell specific voltages which are applied to the mirror 100. Advantageously, measuring and further correcting the wave front re-emitted by the magnetic mirror provides a feedback loop through which performance of the mirror may be monitored. In an embodiment, at least one of these functions is performed by the processor 300 using instructions stored on memory 500. In an embodiment, the functions of the first aberrometer 200 and the second aberrometer 700 are combined in a single aberrometer optically coupled to both the optical system front section 15 and rear section 17.

A method of controlling aberration in an optical system comprises aberrating 500 a transmitted wave front, measuring 510 the aberrated wave front, measuring 520 at least one cognizable form of aberration in the wave front, comparing 530 the measured aberration of the first wave front to a reference wave front, determining 540 a wave front correction based on the comparison, and re-emitting 550 with a phase-controllable magnetic mirror a corrected wave front based on the determined wave front correction. Advantageously, the method allows for controlling the contour of the aberrated wave front by re-emitting a corrected wave front having a different wave front contour. Advantageously, the re-emitted wave front may have a contour more similar to a reference wave front.

In an embodiment, the method further comprises measuring 560 the re-emitted wave front, determining 570 the amount of aberration in the re-emitted wave front, comparing 580 the amount of aberration in the second wave front to the reference wave front, and determining 590 a second wave front correction based on the determined aberration in the re-emitted wave front. Advantageously, the method allows for monitoring and iteratively adjusting the wave front re-emitted by the phase-controllable magnetic mirror.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Moreover, embodiments of the magnetic mirror described herein should not be confined to gravity wave detection applications, such as Applicant's LISA—Laser Interferometer Space Antenna, or planet finding applications, such as Applicant's FKSI—Fourier-Kelvin Stellar Interferometer. Embodiments of the deformable magnetic mirror described herein are also of use in laser guide star applications in astronomy and surveillance, where phase variation from light passing through atmospheric turbulence may be measured and removed—thereby allowing for consistent optical system performance irrespective of atmospheric conditions. Moreover, embodiments of the magnetic mirror described herein are suitable in any application where it is advantageous to control and/or reduce the aberration of a wave front. For example, embodiments of the mirror are suitable for imaging applications, such as photolithography in semiconductor manufacturing as well as in communications, as well as in any other application where controlling and/or reducing wave front aberration is advantageous.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A phase controllable magnetic mirror, comprising:
a ground plate having a surface;
a dielectric layer disposed over the ground plate surface and having a plurality of electrically-isolated sections; and
a first unit cell and a second unit cell connected to the ground plate and the dielectric layer,
wherein the first and the second unit are configured to have different electric potentials, and
wherein the plurality of unit cells are configured to receive incident photons at a first phase and re-emit photons at a second phase.

2. The mirror of claim 1, wherein a difference between the phases of photon emitted by the first unit cell and the second unit cell corresponds to a difference in the electric potentials of the first unit cell and the second unit cell.

3. The mirror of claim 1, wherein the dielectric layer comprises a plurality of controllable dielectric portions configured to apply an electric potential to the connected unit cell.

4. The mirror of claim 1, wherein at least one of the unit cells further comprises a sinusoidal-shaped nanowire connected to the dielectric layer and the ground plate.

5. The mirror of claim 1, wherein at least one of the unit cells further comprises a nano-ring nanowire connected to the dielectric layer and the ground plate.

6. The mirror of claim 5, wherein the nano-ring has a diameter of approximately 60 nanometres and a thickness of approximately 10 nanometres.

7. The mirror of claim 1, wherein the ground plate further comprises aluminum.

8. The mirror of claim 1, wherein an index of refraction of the dielectric layer correspondingly changes with a bias voltage applied to dielectric layer.

9. The mirror of claim 8, wherein the dielectric layer configured to locally change an index of refraction of the dielectric layer in response to a locally applied bias voltage.

10. A method for controlling aberration in an optical system, the method comprising:
at an optical system comprising a front section and a phase-controlled magnetic mirror optically coupled to the front section of the optical system,
aberrating a first wave front propagating through the front section of the optical system, the first wave front comprising a first wave front contour; and
re-emitting, at the phase-controllable magnetic mirror, the second wave front comprising a second wave front contour,
wherein the second wave front contour is different than the first wave front contour.

11. The method of claim 10, wherein the optical system further comprises an aberrometer optically coupled to the front section of the optical system, and a controller connected to the aberrometer and the phase-controlled magnetic mirror, and the method further comprises:
measuring, using the aberrometer, the first wave front contour;
determining, using the controller, aberration of the first wave front; and
comparing, using the controller, the aberration of the first wave front to a reference wave front,
wherein the re-emitting a second wave front comprises a second wave front having a contour more similar to the reference wave front than the first wave front.

12. The method of claim 11, wherein the optical system further comprises a rearward section, and wherein the aberrometer is configured to measure aberration of the second wave front, the method further comprising:
measuring, using the aberrometer, the second wave front contour;
determining, using the controller, aberration of the second wave front; and
comparing, using the controller, the aberration of the second wave front to the reference wave front,
re-emitting a third wave front comprising a third wave front having a contour more similar to the reference wave front than the first wave front and the second wave front.

13. The method of claim 10, wherein aberration of the second wave front is less than aberration of the first wave front.

14. The method of claim 10, wherein aberration of the second wave front comprises less higher order aberration than first wave front higher order aberration.

15. The method of claim 10, wherein residual aberration of the second wave front is lower than the first wave front residual aberration.

16. The method of claim 11, further comprising:
measuring, using the aberrometer, the first wave front contour;
determining, using the aberrometer measurements, a first portion of wave front aberration comprising at least one of lower-order astigmatism, lower-order coma, and lower-order spherical aberration; and
determining, using the aberrometer measurements, a second portion of wave front aberration comprising at least one of higher-order astigmatism, higher-order coma, and higher-order spherical aberration.

17. The method of claim 16, wherein the optical system further comprises an adaptive lens optically coupled to the forward section of the optical system, and the method further comprises:
controlling, using the adaptive lens, at least one of the determined lower-order astigmatism, lower-order coma, and lower-order spherical aberration; and
controlling, using the phase-controlled magnetic mirror, at least one of higher-order astigmatism, higher-order coma, and higher-order spherical aberration,
wherein at least one of the determined lower-order astigmatism, lower-order coma, and lower-order spherical aberration the aberration of the second wave front is smaller than the aberration of the first wave front, and
wherein at least one of the higher-order astigmatism, higher-order coma, and higher-order spherical aberration of the second wave front is smaller than the aberration of the first wave front.

18. The method of claim 16, further comprising:
determining, using the aberrometer measurements, a third portion of wave front aberration comprising residual error not quantified using at least the first thirty-six (36) polynomial terms of an expansion of Zernike's equation; and
controlling, using the phase-controlled magnetic mirror, the determined residual error,
wherein the residual error of the second wave front not quantified using at least the first thirty-six (36) polynomial terms of an expansion of Zernike's equation is smaller than a residual error of the first wave front not quantified using at least the first thirty-six (36) polynomial terms of an expansion of Zernike's equation.

19. A phase-controllable magnetic mirror system, comprising:
a phase-controllable magnetic mirror having a plurality of unit cells, each unit cell having a controllable dielectric constant;
a processor connected to the phase-controllable magnetic mirror; and
a first aberrometer connected to the processor and the phase-controllable magnetic mirror,
wherein the first aberrometer is configured to measure a wave front of incident light,
wherein the processor is configured to analyse the aberration measurements and determine a plurality of dielectric constant changes for the plurality of unit cells, and
wherein the phase-controlled magnetic mirror is configured to re-emit the incident having a corrected wave front based on the determined plurality of dielectric constant changes.

20. The phase-controllable magnetic mirror system of claim 19, further comprising:
a second aberrometer connected to the processor and the phase-controllable magnetic mirror,
wherein the second aberrometer is configured to measure a wave front of the re-emitted light, and
wherein the processor is further configured to iteratively analyze the aberration measurements from the first aberrometer and the second aberrometer and determine a plurality of dielectric constant changes for the plurality of unit cells.
